(19) United States
(12) Patent Application Publication
(10) Pub. No.: US 2003/0157850 A1
(43) Pub. Date: Aug. 21, 2003

(54) Reinforced decorative composite material

(76) Inventor: Steven J. Taylor, Massillon, OH (US)

Correspondence Address: FITZPATRICK CELLA HARPER & SCINTO, 30 ROCKEFELLER PLAZA, NEW YORK, NY, 10112, US

(21) Appl. No.: 10/081,629

(22) Filed: Feb. 20, 2002

(51) Int. Cl. B32B 31/00; B32B 31/20

(52) U.S. Cl. 442/1; 156/288; 156/308.2

(57) ABSTRACT

A reinforced composite material includes a laminate panel, a strengthening panel that includes a reinforcement embedded therein, and a layer of adhesive disposed between the laminate panel and the strengthening panel to adhere the laminate panel and the strengthening panel together. Preferably, the reinforcement in the strengthening panel may be fiberglass fibers, randomly oriented, or it may be provided in the form of a mesh or the like. In either case, the strengthening panel is preferably a plastic (polymeric) material of the type known as fiberglass reinforced polyester. Also provided is a method for the production of such a material.

### BACKGROUND OF THE INVENTION

1. Field of the Invention

The present invention relates generally to construction materials and more particularly to a reinforced decorative composite material that includes a laminated material of the type called high pressure laminates (“HPL”) and a strengthening panel such as fiberglass reinforced plastic (“FRP”) adhered together, and to the manufacture of such a composite material.

2. Description of Related Art

High pressure laminate materials have been manufactured and sold for many years, and are familiar to many from their wide-spread use in kitchens and areas requiring very durable and decorative surface attributes. Such laminates are typically made of layers of paper impregnated with resin, compressed in a press or the like and heated to produce the desired laminate. One layer of paper may have a decorative pattern that remains visible in the finished product. The exact types of paper and of resins used, as well as the pressures, equipment and temperatures used, and the precise order of steps, are well known to those in the art. A great variety of products of this type are commercially available from the Formica Corporation, under the trademark Formica, owned by that company. Examples of techniques and materials used in the manufacture of such laminates can be found in U.S. Pat. No. 5,558,906, assigned on its face to Formica Technology Inc., the entire disclosure of which is incorporated herein by reference, although it is to be understood that the present inventor does not claim ownership of the processes claimed in that patent, which are believed to be owned by that patent's assignee of record.

HPL products, however, are generally brittle enough that they must be mounted on a layer of wood or other material of sufficient strength and rigidity, for use in the kitchen, and on any horizontal surface. Vertical surface applications of HPL's would be enhanced by a pre-laminated panel with the HPL as the outward side. A primary application of the proposed panel would be vertical wall surfaces, where drywall is a common substrate.

It would be desirable to be able to use HPL products in environments where the product will be exposed to relatively high levels of wear and tear, moisture, and mechanical loads, without the need to mount the HPL on a mechanically strong layer of wood or other materials. For example, it would be desirable to be able to use decorative materials like HPL products in vertical wall applications in schools, hospitals, restaurants and other public areas that are subject to large amounts of traffic, and where conventional HPL cannot easily be used.

Also known are sheets of plastic reinforced with fiberglass, which have long been employed as surfaces that are resistant to abuse (that is, resistant to tearing and the like), and resistant to moisture as well. Such products are obtainable commercially, for example, from Kemlite Company, the assignee of the present invention, and some techniques and materials for use in for their manufacture are disclosed in commonly-assigned U.S. Pat. Nos. 4,278,491, 4,110,151, 4,098,630 and 4,048,887, the entire disclosure of each of which patents is incorporated herein by reference. FRP products thus far typically have an embossed surface, are a solid color (typically white), and have a hard and shiny appearance that makes them unsuitable for uses where aesthetic appearance is of great concern.

### SUMMARY OF THE INVENTION

Accordingly, one object of the present invention is to provide a material that will have the aesthetic qualities of HPL and can be easily installed on vertical surfaces. It is also an object to provide such a material that will have sufficient mechanical strength for use in situations where conventional HPL products might not otherwise be usable, such as wall panel applications without a substantial structural substrate. Of primary importance, the present invention provides a panel which is installer-friendly and combines the custom color/pattern flexibility of an HPL face with a water-proof, dimensionally stable, user-friendly backer. Further, this laminated panel enhances the impact resistance and moisture resistance of known available decorative vertical wall panels. The subject panel will allow installation of an HPL vertical surface in a most expeditious manner saving labor costs in two ways: drywall preparation, and actual installation time of the panel, when compared to applying HPL directly over drywall.

These objects are met by the present invention, according to one aspect of which is a reinforced composite material that includes a laminate panel, a strengthening panel that includes a reinforcement embedded therein, and a layer of adhesive disposed between the laminate panel and the strengthening panel to adhere the laminate panel and the strengthening panel together. Preferably, the reinforcement in the strengthening panel may be fiberglass fibers, randomly oriented, or it may be provided in the form of a mesh or the like. In either case, the strengthening panel is preferably a plastic (polymeric) material of the type known as fiberglass reinforced polyester. The thicknesses of the layers may be selected according to need, but as examples, the HPL may be about 0.030 inch thick, and the strengthening panel may for example be 0.030, 0.060 or 0.090 inch thick, although the invention is not limited to these specific thicknesses and combinations of thicknesses.

The invention also provides a method for the production of such a material, in which there are provided a laminate panel of a type made by heating and compressing at least a first layer of paper and quantity of resin, and a strengthening panel of a type made by embedding a reinforcement in a layer of a binder material. Then, the laminate panel is adhered to the strengthening panel with a layer of adhesive. The adhesive may preferably be a contact cement or a hot melt adhesive.

These and other objects, features and advantages of the present invention will be more fully apparent from a consideration of the following detailed description of the preferred embodiments, taken in conjunction with the accompanying drawings.

### BRIEF DESCRIPTION OF THE DRAWINGS

FIG. 1 is a view of a preferred embodiment of a composite material according to the present invention.

FIGS. 2a and 2b are details showing two varieties of FRP that may be used in the embodiment shown in FIG. 1.

FIG. 3 is a chart illustrating a method of manufacturing a material according to the present invention.

### DESCRIPTION OF THE PREFERRED EMBODIMENTS

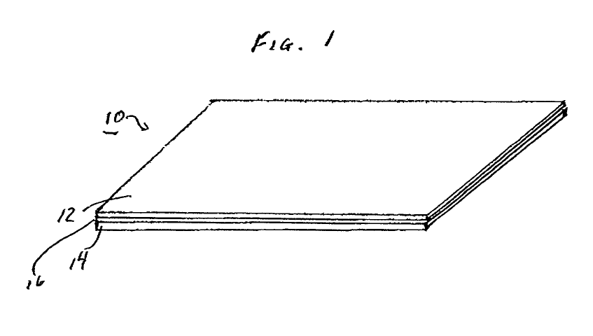

The first preferred embodiment of the present invention is a reinforced composite material 10 having three layers, as shown in FIG. 1. Two outer layers 12, 14 sandwich, and are secured together by, a third layer 16, of adhesive. One of the outer layers 12 is a HPL material, and the other of the outer layers 14 is a sheet or panel of a reinforced material. The intermediate layer 16 is of an adhesive material. The reinforced material may be a FRP material of a type available from Kemlite Company, while the other outer layer 12 is for example of a type available from the Formica Company. The exact choice of adhesive is not critical, and it is believed that many commercially available adhesives are suitable for adhering combinations of HPL and FRP materials in this fashion. The present inventor particularly contemplates, however, the use of a conventional contact cement or of a conventional hot-melt adhesive, a great number of both of which are known in the art, and detailed description of which is therefore not required. Nonetheless, the key quality of the adhesive used is not that it be either a contact cement or a hot-melt adhesive, nor that it be any other particular kind, but that it provide the bonding qualities necessary to bond securely with the particular HPL and FRP materials used in a given instance. The selection of the right adhesive for a particular choice of the outer layers, thus, is well within the ordinary skill in the art, and the use of any adhesive whatever that provides these qualities is within the scope of the invention.

While it is preferred to use a sheet of FRP material for the reinforcing sheet, it is also possible to use other types of reinforced plastic. For example, a plastic sheet 14′ having reinforcing material in the form of a mesh 18′, rather than in the form of randomly-oriented fiberglass 18, as in FRP, forms a second preferred embodiment of the invention. FIGS. 2a and 2b indicate these two types of material for use in the composite material shown in FIG. 1. In addition, both types of reinforcement may be used together.

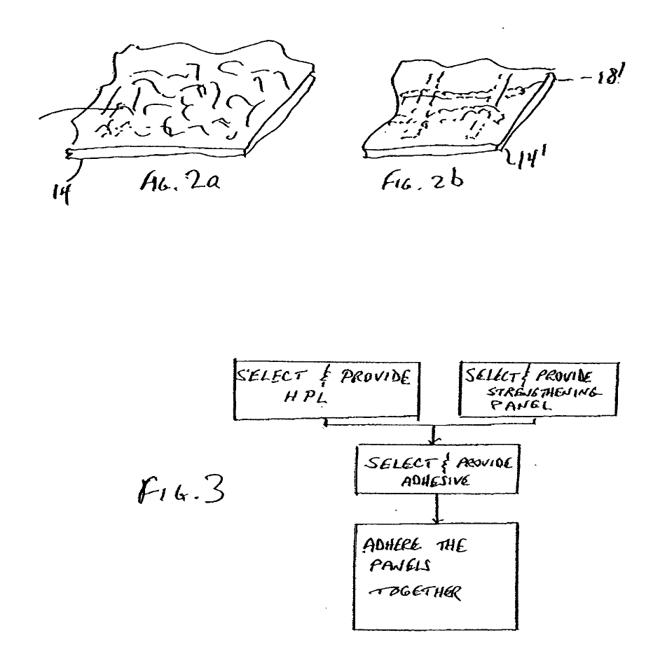

The method of manufacturing the composite material shown in FIG. 1 is straightforward, and is illustrated in FIG. 3. First, one selects the appropriate HPL and reinforced plastic materials to use as the outer layers. While these materials may be custom manufactured, either or both may be a commercially available material instead. Once these two materials have been formed, or otherwise provided, the appropriate materials and techniques for adhering the two layers to each other can be selected and used.

The thicknesses of the layers of the reinforced composite material may be selected according to need, but as examples, the HPL may be about 0.030 inch thick, and the strengthening panel may be 0.030, 0.060 or 0.090 inch thick, although the invention is not limited to these specific thicknesses and combinations of thicknesses.

While the present invention has been described in detail with reference to the currently-preferred embodiments, many modifications and variations of those embodiments will now be apparent to those skilled in the art. Accordingly, the scope of the invention is not to be limited by the details of the foregoing detailed description, but only by the terms of the appended claims.

What is claimed is:

1. A reinforced composite material comprising:
a laminate panel;
a strengthening panel, the strengthening panel including a reinforcement embedded therein; and
a layer of adhesive disposed between the laminate panel and the strengthening panel to adhere the laminate panel and the strengthening panel together.

2. The reinforced composite material as set forth in claim 1, in which the strengthening panel further includes a sheet of plastic.

3. The reinforced composite material as set forth in claim 2, in which the reinforcement is embedded in the sheet of plastic.

4. The reinforced composite material as set forth in claim 2, in which the sheet of plastic is at least partially formed of a polyester copolymer.

5. The reinforced composite material as set forth in claim 1, in which the strengthening panel is a sheet of fiberglass reinforced plastic.

6. The reinforced composite material as set forth in claim 1, in which the reinforcement includes a plurality of fibers of a reinforcing material.

7. The reinforced composite material as set forth in claim 6, in which the plurality of fibers of the reinforcing material are one of randomly oriented and oriented in a mesh within the strengthening panel.

8. The reinforced composite material as set forth in claim 6, in which the plurality of fibers of the reinforcing material are at least partially formed of glass.

9. The reinforced composite material as set forth in claim 1, in which the layer of adhesive includes a layer of a material selected from the group consisting of contact cement and hot melt adhesive.

10. A reinforced composite material comprising:
a laminate panel;
a strengthening panel including a fibrous reinforcement embedded in a polymeric material; and
a layer of adhesive disposed between the laminate panel and the strengthening panel to adhere the laminate panel and the strengthening panel together.

11. The reinforced composite material as set forth in claim 10, in which the fibrous reinforcement includes a plurality of fibers of glass.

12. A method of forming a reinforced composite material, the method comprising the steps of:
forming a laminate panel by heating and compressing at least a first layer of paper and quantity of resin;
forming a strengthening panel by embedding a reinforcement in layer of a binder material; and
adhering the laminate panel to the strengthening panel with a layer of adhesive.

13. The method as set forth in claim 12, in which the step of forming a strengthening panel includes the step of providing a sheet of fiberglass reinforced plastic.

14. The method as set forth in claim 12, further comprising the steps of applying a layer of hot melt adhesive between the laminate panel and the strengthening panel and curing the layer of hot melt adhesive.

15. A method of forming a reinforced composite material, the method comprising the steps of:
providing a laminate panel of a type made by heating and compressing at least a first layer of paper and quantity of resin;
providing a strengthening panel of a type made by embedding a reinforcement in layer of a binder material; and
adhering the laminate panel to the strengthening panel with a layer of adhesive.

16. The method as set forth in claim 15, in which the strengthening panel is a sheet of fiberglass reinforced plastic.

17. The method as set forth in claim 15, wherein said adhering step further comprises the steps of applying a layer of hot melt adhesive between the laminate panel and the strengthening panel and curing the layer of hot melt adhesive.

18. The method as set forth in claim 15, wherein said adhering step further comprises the step of applying a layer of a contact cement between the laminate panel and the strengthening panel.
